(19) United States
(12) Patent Application Publication
(10) Pub. No.: US 2006/0191912 A1
(43) Pub. Date: Aug. 31, 2006

(54) Carrier for an induction coil, induction heating device, induction hob and method for the manufacture of an induction heating device

(75) Inventor: Bernhard Roth, Oberderdingen (DE)

Correspondence Address: AKERMAN SENTERFITT, P.O. BOX 3188, WEST PALM BEACH, FL, 33402-3188, US

(73) Assignee: E.G.O. Elektro-Geraetebau GmbH, Oberderdingen (DE)

(21) Appl. No.: 11/341,981

(22) Filed: Jan. 27, 2006

(30) Foreign Application Priority Data
Jan. 31, 2005 (DE) 102005005526.5

(51) Int. Cl. H05B 6/36

(52) U.S. Cl. 219/675

(57) ABSTRACT

A carrier for a flat induction coil of an induction heating device has an upper supporting plate and a lower supporting plate. The plates are mechanically interconnected and form a narrow gap for the introduction of the induction coil formed by a single, continuous coil wire in several windings. As a result of the mutual spacing of the two supporting plates, the coil wire can be secured and is therefore fixed in position.

The following disclosure is based on German Patent Application No. 102005005526.5 filed on Jan. 31, 2005, which is herewith incorporated into this application by explicit reference.

### FIELD OF APPLICATION AND PRIOR ART

The invention relates to a carrier for an induction coil, particularly having a flat or shallow construction, as well as an induction heating device and a method for the manufacture of such an induction heating device and an induction hob.

It is known for example from U.S. Pat. No. 5,686,006 in the case of an induction heating device of an induction hob to wind in single layer form the coil wire onto a carrier with prefabricated grooves or groove-like depressions and it is for example fixed by bonding.

### PROBLEM AND SOLUTION

The problem of the invention is to provide an aforementioned carrier, an induction heating device and a method for the manufacture of an induction heating device obviating the prior art difficulties and in particular enabling the simple manufacture of an induction coil with a precisely defined shape and construction.

The set problem is solved by a carrier for an induction coil with a substantially flat and extension along plane or an area, said carrier having upper means and lower supporting means, both supporting means being mechanically interconnected and forming a narrow gap for the introduction of the induction coil. The problem is also solved by an induction heating device with an induction coil and with an aforementioned carrier, together with an induction hob having the aforementioned induction heating device. The problem is additionally solved by a method for the manufacture of an induction coil with a carrier, which has a substantially flat and extension in an area and upper means and lower supporting means, said two supporting means being mechanically interconnected. They form a narrow gap for the introduction of the induction coil and, starting on the radial inside on the carrier an induction coil wire is wound into the gap between the supporting means, winding taking place radially from the inside to the outside. Advantageous and preferred developments of the invention form the subject matter of further claims and are explained in greater detail hereinafter. By express reference the wording of the claims is made into part of the content of the description. Features describing both the carrier and the induction heating device and manufacturing method are in part only referred to once hereinafter. However, independently of one another, they apply to the carrier, induction heating device and the manufacturing method for the same.

The carrier has upper supporting means and lower supporting means forming a narrow gap. They can for example be constructed in a substantially plate-like or in the form of a plane. Into said narrow gap, which can also be in the form of a very deep groove, the induction coil is introduced or inserted. The induction coil is advantageously formed from a continuous coil wire, which with particular advantage is a relatively thick multiple strand. An insulation of the coil wire to the outside or the individual strands advantageously takes place by a varnish-like coating, in place of a coating-like plastic jacket. With particular advantage the coil wire is wound into the gap in such a way that the resulting induction coil is in single layer form.

It is advantageously possible with a single layer induction coil, particularly if the mutual spacing of the two supporting means or the gap is much the same as the coil wire thickness and the coil wire is placed in the gap under a slight clamping action. This makes it possible to fix the coil wire or the individual windings in position for a stable, permanent construction of the induction coil or an induction heating device. There is no need for further bonds or fixtures.

It is possible to manufacture the carrier as a subassembly or substantially or completely from a single part. The supporting means can be connected to a connecting piece, which is particularly shaped in the central area. Complicated assembly steps before and after winding on or introduction of the coil wire are consequently unnecessary. It can be made from plastic. Alternatively, at least the lower supporting means can comprise ferromagnetic material, for example can be in strip form with a radial direction or can comprise the same and this in particular also applies to the upper supporting means. Thus, the magnetic field can be diverted and in this way the overall inductance of the induction coil is modified.

The supporting means form advantageous supporting surfaces bounding the gap and therefore the space into which is introduced the induction coil or coil wire. For the construction of the supporting means or the supporting surfaces formed by them a number of different possibilities exist. It is firstly possible to construct them in full-surface manner or as closed supporting surfaces. This makes it possible to create a very stable carrier for example. It is also possible for at least one of the supporting means or supporting surfaces to have recesses and/or openings. They can perform numerous functions, as will be described hereinafter. For example, openings can serve as ventilation apertures for cooling the induction coil. Material and weight can also be saved. A construction of supporting means with openings can for example be built up in the manner of a spoked wheel, the coil wire engaging on the spokes. Further possibilities exist for an advantageous manufacturing method and these will be described in greater detail hereinafter.

At least one or both of the supporting surfaces can be constructed in substantially planar manner or without elevations. Alternatively a row of elevations can be located on at least one of the supporting surfaces. They can define the path of the coil wire in the form of spacers or introduction grooves or prefabricated paths. This is particularly advantageous if the mutual positioning of the windings is to be precisely defined and in particular if the windings should not engage with one another and instead have a certain mutual spacing. These elevations can have an elongated structure and follow the coil windings or gaps. However, for saving material, they can also comprise a row of adjacent elevations defining the spiral path.

The elevations can project over a supporting surface of a supporting means to such an extent that they form a certain stop for the coil wire. However, on introducing or winding on the coil wire it must still be possible to press it with a certain force through a narrowed cross-section into the inner area of the coil or the gap between the supporting means. In particular a multistrand coil wire here offers an advantageous deformability. A cross-sectional reduction in the gap through the elevations can be between approximately 10 and 20%. This is also considered adequate to bring about a sufficient positional fixing.

The path of the induction coil or coil wire predeterminable by such elevations can be such that in the central area there is either no spacing or a very limited spacing between adjacent windings. The spacing can increase towards the outside, because this can define a type of power density of the induction heating device.

The interconnection of the two supporting means in a central piece or central area can be integral, as stated hereinbefore. It is additionally possible following the winding on of the induction coil to provide in the outer area further connections or fixtures, because then the gap need no longer be accessible. A connecting piece in the centre can have an opening or a hole in order to render said area accessible. For example, a temperature sensor can be introduced into the same and measures the temperature above the induction coil. Particularly when using an induction heating device in an induction hob this is of interest in order to determine the temperature of a glass ceramic hotplate above the same or indirectly the temperature of a cooking vessel placed thereon. The connecting piece can have fastening possibilities for a temperature sensor, for example locking projections or recesses.

Onto an outside or top side of the carrier can be shaped spacers or the like. With the aid thereof it can in particular be applied to the underside of a glass ceramic plate with a precisely defined spacing, particularly as an induction heating device in an induction hob.

According to a further development of the invention the aforementioned openings or apertures can be so constructed in at least one of the supporting means and can be used for introducing spacers from the outside into the gap. This is particularly advantageous if juxtaposed windings of the induction coil have a certain mutual spacing. Thus, following the winding in of a winding a spacer can be introduced on its radial outside. As it is introduced from the outside through one of the supporting means, it does not hinder the introduction of the coil wire. The introduced spacer advantageously engages on the inner winding or defines the radial spacing of the outer winding. The said spacers can in particular be rod-like or projection-like. With particular advantage they engage in both supporting means and are consequently fixed in position. When the induction coil is wound up, they can remain in the carrier for a permanent induction coil design.

Apart from the actual induction coil, ferrites can be provided on the carrier, for example on an underside. In particular they are relatively flat and have a spoke-like or radial configuration. They can be introduced, fixed or bonded into corresponding receptacles on the underside of the carrier.

During the manufacture of the induction coil winding starts from the radial inside. Since, starting from the radial inside, a connection possibility must be created, on one of the supporting means can be provided an opening or a passage through which the start of the coil wire for the induction coil can be led to the outside. For the simplified passage of the coil wire, said passage can be enlarged. It is advantageously elongated or in the form of a wide slit, which extends radially into an outer area and in particular to shortly before the outer edge or even through the latter. As a result the passage of the coil wire is relatively simple. In addition, such a radially directed slit does not impede the supporting of the individual circumferentially directed coil windings, which are therefore essentially at right angles thereto. As stated hereinbefore, such a slit can also assume functions such as cooling air supply or the like.

Following the introduction of one end of the induction coil or coil wire, the actual winding up process can commence. Numerous possibilities exist for this and in particular the carrier rotates with the coil wire supply fixed. Through the precise definition of the gap height between the supporting means or through the aforementioned elevations, it is possible for the coil wire to be adequately precisely fixed in position by a clamping action. Thus, the induction coil can be manufactured without bonding or other fastenings.

These and further features can be gathered from the claims, description and drawings and the individual features, both singly or in the form of subcombinations can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Embodiments of the invention are diagrammatically illustrated in the attached drawings, wherein show:

FIG. 1 A lateral section through a carrier with different construction possibilities or details.

FIG. 2 A carrier corresponding to FIG. 1 with a wound up induction coil.

FIG. 3 A section through an induction hob with induction heating device and an induction coil corresponding to FIG. 2 placed below a glass ceramic hotplate.

### DETAILED DESCRIPTION OF EMBODIMENTS

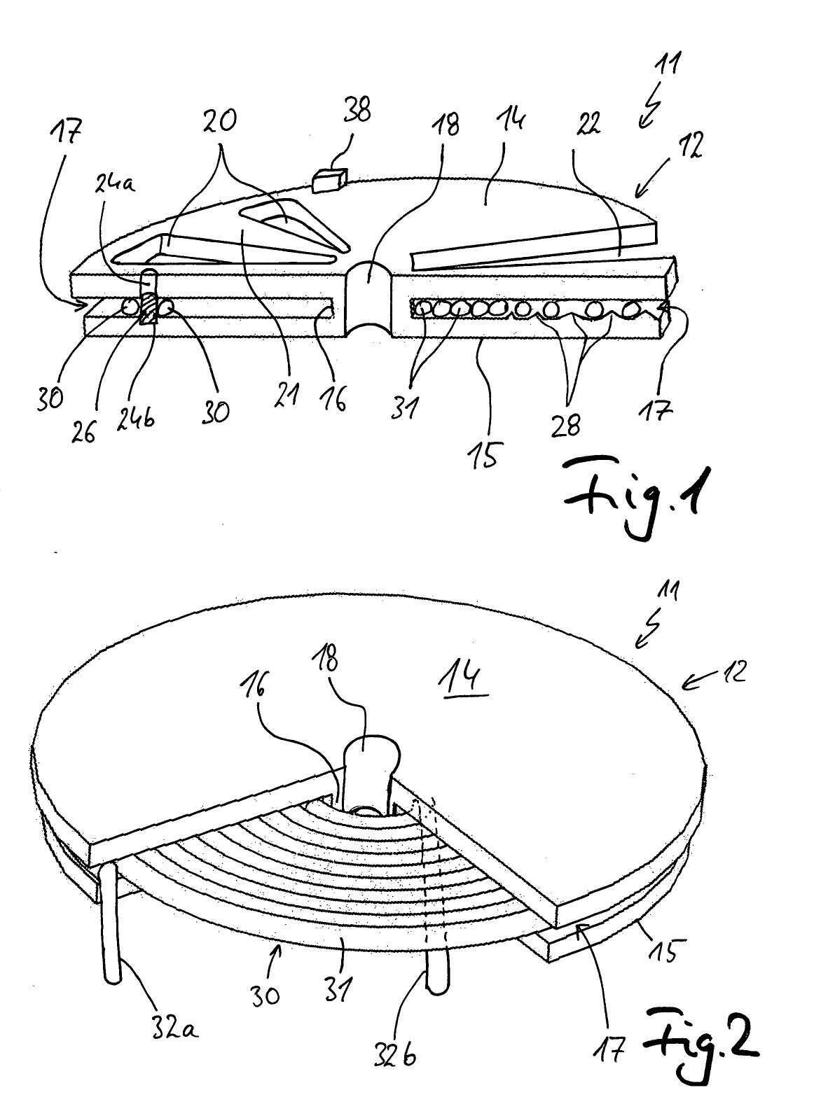

FIG. 1 shows in exemplified manner an induction coil 11 and various construction possibilities are illustrated. The induction coil 11 has a carrier 12. It comprises an upper plate 14 as the upper supporting means and a lower plate 15 as the lower supporting means. The two plates 14, 15 are connected by a centrepiece 16 and in particular the entire carrier 12 is integrally constructed, for example from plastic.

In the centrepiece 16 is provided a central recess 18 as an elongated hole, which can fulfil various functions, inter alia for the passage of a temperature sensor for engaging on a hotplate located above the same. It is also used for the passage of a cooling air flow. The central recess 18 also saves material.

It is also possible to provide in the surface of one of the two plates 14, 15 or in both plates ventilation openings 20 with intermediate webs 21. They can for example be constructed as radially directed slots. Apart from the improved ventilation function, they can also save material. It is also possible to bring about a supply here to the coil wire winding between the plates 14, 15. As the webs 21 of plates 14, 15 are also located between the ventilation openings 20, an adequate supporting or positional securing of the windings 30 is ensured. It is for example also possible to arrange the ventilation openings 20 in the upper plate 14 so as to be offset with respect to those of the lower plate 15. The webs 21 and the outer circumferential rim in such a case create an adequate supporting surface for the windings 30.

To the right on carrier 12 is shown in exemplified manner how a ventilation opening can pass through the right-hand side in the form of slot 22 or is open to the edge. Into such a slot can be laterally introduced in particularly advantageous manner an inner connection end for the induction coil or the windings 30.

In the left-hand area of the carrier 12 is also shown how it is possible to provide a hole 24 for a spacer 26. Said hole 24 passes as hole 24a through the upper plate 14 and extends in part as lower hole 24b into the lower plate 15. A spacer 26 is introduced into said hole 24, advantageously by clamping. From the outlet, this takes place following the introduction of the inner winding 30 to the right alongside spacer 26. From the outside the next outer winding 30 is then wound onto the left-hand side of the spacer 26, so that then between the two windings is maintained a spacing with the spacer thickness. As a result of different placing of the holes 24 or thickness of the spacer 26, it is possible to vary the spacings between juxtaposed windings.

An alternative method to the spacer 26 is shown in the right-hand area, where the windings 30 are directly juxtaposed or contact one another in a central area of the induction coil. As from roughly half the radius elevations 28 are provided and in the embodiment shown they are formed on the supporting surface constituted by the lower plate 15. The elevations 28 become wider with increasing radius of the windings. Thus, the spacing of juxtaposed windings 30 increases, which can inter alia take place for reducing the power density in the radially outer area.

In one development the elevations 28 can be in the form of longitudinal elevations, which have a spiral configuration corresponding to the path of the individual windings 30. They can either be continuous, or can be constructed with mutual spacings as individual elevations along an imaginary line and as a result form a type of line or linear stop for each individual winding.

The height of the elevations 28 is advantageously such that on introducing the coil wire 31 or windings 30 they are introduced from the radial outside. They are introduced with sufficient force that they just overcome sufficient elevations 28 to enable them to follow the correct track. The elevations 28 can be given a flat, central protuberance. Preferably and as shown they are constructed with a triangular cross-section, constant height and varying width. Thus, the windings 30 are centred at the lowest point between two elevations 28 and in the desired position.

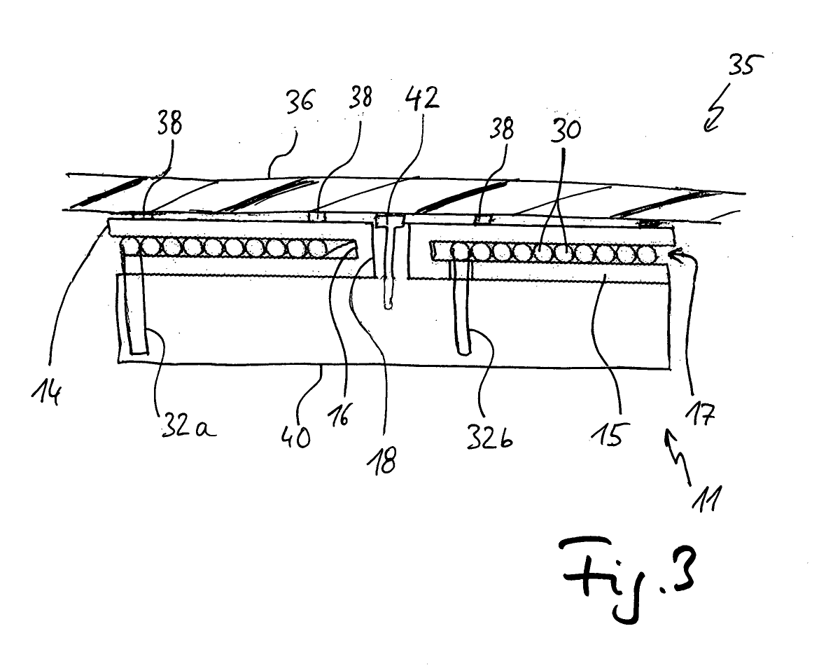

FIG. 2 shows an induction coil 11 in partial section with introduced windings 30 of coil wire 31. However, compared with FIG. 1 there is here a constant mutual spacing of the windings 30 or the latter are in precise engagement with one another. Thus, there are no spacers 26 or similarly functioning elevations 28. It is also clear that the thickness of the coil wire 31 roughly corresponds to the height of the groove 17 between plates 14 and 15, so that there is a very good fixing of the position.

FIG. 2 also shows connections on the induction coil 11, namely an outer connection 32a and an inner connection 32b. In particular, the inner connection 32b can be passed out through a corresponding opening, for example a ventilation opening 20 or a slot 22 according to FIG. 1 on the lower plate 15.

FIG. 3 shows in section an induction hob 35, an induction coil 11 being positioned below a glass ceramic hotplate 36. Its carrier 12 or the upper carrier plate 14 has spacers 38 constructed as elevations. Thus, the induction coil 11 with the top of plate 14 engages on the underside of the glass ceramic plate 36.

In much the same way as in FIGS. 1 and 2, in groove 17 the carrier 12 has several windings 30 of a coil wire 31. Corresponding connections 32a, 32b are led out and in particular guided into a supply 40 in which the induction coil 11 is supplied with power via connections 32. No further details regarding the supply 40 are necessary, because such a connection can be readily implemented by an expert.

A central recess 18 passes through a centrepiece 16 in the centre of carrier 12 and in the same is located a temperature sensor 42. Its upper part engages on the underside of the glass ceramic plate 36 and can determine the temperature thereof. This more particularly serves to prevent overheating of the glass ceramic plate and to give the temperature thereof to a hot indicator or the like of the hob 35.

In much the same way as the inner connection 32b can be fixed through a corresponding slot or opening in the lower plate 15, the outer connection 32a can pass through a similar opening. However, there is no fixing by radially outwardly connecting windings 30, so that there must be a clamping action in the slot in lower plate 15. Alternatively fixing can take place by bonding or by leading the connection 32a to a supply 40 according to FIG. 3 a securing in position can take place.

1. Carrier for an induction coil, said carrier having with a substantially flat extension in an area or along a plane and having upper supporting means and lower supporting means, said two supporting means being mechanically interconnected and forming a narrow gap for the introduction of the induction coil between them.

2. Carrier according to claim 1, wherein said induction coil is in the form of a single, continuous coil wire.

3. Carrier according to claim 1, wherein said carrier is constructed integrally in one piece such that said two supporting means are made from one piece.

4. Carrier according to claim 3, wherein said carrier is constructed integrally and in one piece with said two supporting means and a connecting piece between said two supporting means.

5. Carrier according to claim 1, wherein at least said lower supporting means comprises ferromagnetic material.

6. Carrier according to claim 4, wherein said two supporting means form an integral module with said connecting piece between them.

7. Carrier according to claim 1, wherein said mutual spacing of said two supporting means is approximately the thickness of said induction coil wire, said spacing of said two supporting means being sufficient for a coil wire of said coil to be located between said supporting means under a slight clamping action.

8. Carrier according to claim 1, wherein said supporting means each form an inwardly directed supporting surface or are directed towards one another or run in such a supporting surface.

9. Carrier according to claim 8, wherein said supporting means are in full-surface form or said supporting surfaces formed for an induction coil wire are substantially closed.

10. Carrier according to claim 1, wherein there are recesses in both said supporting means in form of ventilation openings for cooling said induction coil.

11. Carrier according to claim 8, wherein said supporting surfaces formed by said two supporting means are planar or have no elevation.

12. Carrier according to claim 8, wherein at least one of said supporting surfaces of said two supporting means have elevations running along an intended path of an induction coil wire of said induction coil or with intended spacings for fixing a spacing between two juxtaposed windings of said coil wires.

13. Carrier according to claim 12, wherein said elevations project so far over said supporting surface of one of said supporting means and reduce a cross-section of said narrow gap that said coil wire can be pressed through or past by force application during winding up of said coil.

14. Carrier according to claim 12, wherein a reduction of a cross-section of the gap is approximately 10 to 20%.

15. Carrier according to claim 12, wherein elevations are constructed in such a way that in a central area of said carrier there is no or only a slight spacing between juxtaposed windings and said spacing increases towards an outer area of said carrier.

16. Carrier according to claim 1, wherein said two supporting means are interconnected mechanically by a connecting piece in a central area.

17. Carrier according to claim 1, wherein an opening for the introduction of a temperature sensor or the like is provided in a central area of said supporting means.

18. Carrier according to claim 1, wherein in at least one opening or aperture of said supporting means is provided for introduction and permanent fixing of rod-like spacers, said rod-like spacers being introduced radially outside of an inner winding of said induction coil prior to introduction of the following radial outer winding of said induction coil, and in this way there is a determination of mutual spacing of juxtaposed windings of said induction coil by said spacers.

19. Induction heating device with an induction coil and with a carrier for the same according to claim 1.

20. Induction heating device according to claim 19, wherein a coil wire of said induction coil is fixed in bonding-free manner or exclusively by mechanical pressure action on said carrier.

21. Induction hob with at least one induction heating device according to claim 19.

22. Method for the manufacture of an induction coil with a carrier, said carrier having a substantially flat and extension in a plane or an area and upper and lower supporting means, said two supporting means being mechanically interconnected and forming a narrow gap for introduction of said induction coil and, starting from the radial inside, onto said carrier a coil wire of said induction coil is wound into said gap between said supporting means, wherein winding takes place radially from radial inside to radial outside.

23. Method according to claim 22, wherein, at an inner end of said induction coil, a connection is passed through a recess in said carrier or one of said supporting means prior to winding up of said induction coil, said recess being significantly larger than a cross-section of said coil wire, said recess extending longitudinally and radially from a starting point of said coil winding in an outwards direction.

24. Method according to claim 22, wherein as from a given winding radius, spacers are introduced into said carrier prior to application of a next outer winding portion of said induction coil.

25. Method according to claim 24, wherein said spacers are introduced directly following the winding of the preceding radially inner winding portion of said induction coil.

26. Method according to claim 22, wherein, as from approximately one third of a radius of said coil, in parallel and simultaneously and radially inside with said coil wire, an elongated, flexible spacer is also wound on and its thickness or cross-section increases with the number of windings applied or the radial extension of said induction coil.

27. Method according to claim 22, wherein said carrier is rotated with a feed of said coil wire being fixed.
